(19) United States
(12) Patent Application Publication
(10) Pub. No.: US 2023/0398765 A1
(43) Pub. Date: Dec. 14, 2023

(54) HIGH-GLOSS PATTERN FILM FOR VEHICLE AND METHOD OF MANUFACTURING THE SAME

(71) Applicant: STEK CO., LTD., Seoul (KR)

(72) Inventors: Inhwan Oh, Seongnam-si (KR); Subin Park, Seoul (KR); Seunghwan Baek, Seoul (KR)

(21) Appl. No.: 17/836,941

(22) Filed: Jun. 9, 2022

(51) Int. Cl. B32B 7/023; B32B 3/30; B32B 7/12; B32B 27/40

(52) U.S. Cl. CPC B32B 7/023; B32B 3/30; B32B 7/12; B32B 27/40; B32B 2307/402; B32B 2307/732; B32B 2605/00; B32B 2307/406

(57) ABSTRACT

The present invention relates to a high-gloss pattern film for a vehicle and a method of manufacturing the same, and more particularly, to a high-gloss pattern film for a vehicle, which has excellent gloss, implements various patterns and colors, and has excellent durability, and a method of manufacturing the same.

### BACKGROUND OF THE INVENTION

### 1. Field of the Invention

The present invention relates to a high-gloss pattern film for a vehicle and a method of manufacturing the same, and more particularly, to a high-gloss pattern film for a vehicle, which has excellent gloss, implements various patterns and colors, and has excellent durability, and a method of manufacturing the same.

### 2. Description of the Related Art

A paint protection film (PPF) has been constructed for the purpose of protecting a painted surface of a vehicle from contamination or scratches caused by stone chips and tree branches. Recently, a color film (color PPF) and a pattern film (pattern PPF) obtained by adding a design element such as a color and a pattern to an existing PPF have been developed.

In general, the PPF may be formed of a PVC material so that the PPF is inexpensive, and may implement various colors and patterns through surface printing and a special treatment so that gloss may be effectively maintained. However, since the PVC material has physical properties such as relatively weak elasticity and tensile strength, the PVC material may be easily damaged even by a small impact.

Meanwhile, the pattern film refers to a PPF to which a pattern including a concavo-convex portion and the like is added, and Korean Patent Registration No. 10-1173918 (“Three-dimensional pattern film, protection cover, and method of manufacturing the same”) discloses a technology for a three-dimensional pattern film in which a pattern is formed on an adhesive layer or a hard coating layer. When such a film is constructed onto the painted surface of the vehicle, a pattern may be imparted to the painted surface, or a color may be changed while imparting a pattern depending on a product.

However, since such a pattern film is vulnerable to an impact or a scratch from an external environment due to the concavo-convex portion, the pattern film may not be suitable for protecting the painted surface of the vehicle. In addition, when a film layer having a self-restoration function is formed on the pattern to restore a scratch, an inner space of the concavo-convex portion may be filled so that a three-dimensional effect of the pattern may be rapidly reduced.
(Patent Document 0001) Korean Patent Registration No. 10-1173918

### SUMMARY OF THE INVENTION

An object of the present invention is to provide a high-gloss pattern film for a vehicle, which has excellent gloss, implements various patterns and colors, and has excellent durability, and a method of manufacturing the same.

To achieve the objects described above, according to one aspect of the present invention, there is provided a high-gloss pattern film for a vehicle, the high-gloss pattern film including: a self-restoration layer including polyurethane methacrylate and an isocyanate curing agent; a first base layer disposed under the self-restoration layer, and including a thermoplastic polyurethane film; a pattern layer disposed under the first base layer, and formed on a top surface thereof with a pattern including a concavo-convex portion; a second base layer disposed under the pattern layer, and including a thermoplastic polyurethane film; and a third base layer disposed under the second base layer, and including an adhesive layer, wherein a portion of the top surface of the pattern layer is laminated to the first base layer so that an empty space caused by the concavo-convex portion is formed between the pattern layer and the first base layer.

In some embodiments of the present invention, the self-restoration layer may include 75 to 90 parts by weight of the polyurethane methacrylate, and 15 to 40 parts by weight of the isocyanate curing agent.

In some embodiments of the present invention, each of the first base layer and the second base layer may include 95 to 100 parts by weight of the thermoplastic polyurethane film.

In some embodiments of the present invention, the high-gloss pattern film for the vehicle may include: an upper film layer including the self-restoration layer and the first base layer; and a lower film layer including the second base layer and the third base layer, the pattern layer may be formed between the upper film layer and the lower film layer, and a top surface of the pattern formed on the pattern layer may be attached to the upper film layer so that the upper film layer, the pattern layer, and the lower film layer may form an integrated structure.

In some embodiments of the present invention, the third base layer may further include a color layer disposed on the adhesive layer, and a thickness of the color layer may be 5 to 50 micrometers.

In some embodiments of the present invention, a thickness of the self-restoration layer may be 5 to 30 micrometers, a thickness of the first base layer may be 25 to 200 micrometers, a thickness of the pattern layer may be 5 to 50 micrometers, a thickness of the second base layer may be 12 to 50 micrometers, and a thickness of the adhesive layer may be 5 to 50 micrometers.

To achieve the objects described above, according to one aspect of the present invention, there is provided a method of manufacturing a high-gloss pattern film for a vehicle, in which the high-gloss pattern film for the vehicle includes: a self-restoration layer including polyurethane methacrylate and an isocyanate curing agent; a first base layer disposed under the self-restoration layer, and including a thermoplastic polyurethane film; a pattern layer disposed under the first base layer, and formed on a top surface thereof with a pattern including a concavo-convex portion; a second base layer disposed under the pattern layer, and including a thermoplastic polyurethane film; and a third base layer disposed under the second base layer, and including an adhesive layer, wherein a portion of the top surface of the pattern layer is laminated to the first base layer so that an empty space caused by the concavo-convex portion is formed between the pattern layer and the first base layer.

According to one embodiment of the present invention, the self-restoration layer may be formed of a material having high elasticity, so that a scratch resistance and water repellency of the high-gloss pattern film for the vehicle can be improved, and thus a painted surface can be effectively protected.

According to one embodiment of the present invention, the first base layer may be disposed between the self-restoration layer and the pattern layer so as to be laminated to the top surface of the pattern formed on the pattern layer, so that the high-gloss pattern film for the vehicle having excellent gloss can be provided.

According to one embodiment of the present invention, the first base layer formed of the thermoplastic polyurethane film and having a relatively thick thickness may be disposed on a surface side, so that durability and an impact resistance of the high-gloss pattern film for the vehicle can be improved.

According to one embodiment of the present invention, a color layer including a color pigment may be separately arranged, so that various colors can be stably implemented.

According to one embodiment of the present invention, the color layer may be formed of a material based on a component that is similar to a component on which materials of the second base layer and the adhesive layer are based, so that the color layer can serve as a primer, and thus the adhesive layer can be prevented from being transferred.

### BRIEF DESCRIPTION OF THE DRAWINGS

FIG. 1 schematically shows a stacked structure of a high-gloss pattern film for a vehicle according to one embodiment of the present invention.

FIGS. 2A and 2B schematically show stacked structures of high-gloss pattern films for vehicles according to one embodiment of the present invention.

FIGS. 3A, 3B, and 3C schematically show external appearances of high-gloss pattern films for vehicles according to one embodiment of the present invention and a comparative example.

FIG. 4 schematically shows a tester used for a glossiness test.

FIGS. 5A, 5B, and 5C schematically show results of an impact resistance test for the high-gloss pattern films for the vehicles according to one embodiment of the present invention and the comparative example.

FIGS. 6A, 6B, and 6C schematically show results of a scratch restoration capability test for the high-gloss pattern films for the vehicles according to one embodiment of the present invention and the comparative example.

FIGS. 7A, 7B, and 7C schematically show results of a water repellence capability test for the high-gloss pattern films for the vehicles according to one embodiment of the present invention and the comparative example.

FIGS. 8A, 8B, and 8C schematically show results of an adhesion retention strength test for the high-gloss pattern films for the vehicles according to one embodiment of the present invention and the comparative example.

### DETAILED DESCRIPTION OF THE INVENTION

Various embodiments and/or aspects will be disclosed with reference to the drawings. In the following description, for the purpose of explanation, numerous specific details are set forth in order to provide a thorough understanding of one or more aspects. However, it shall also be appreciated by a person having ordinary skill in the art to which the present invention pertains that such aspect(s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to include all the various aspects and equivalents thereof.

The terms “embodiment”, “example”, “aspect”, “illustration”, and the like used herein may not be construed as indicating that an aspect or design set forth herein is preferable or advantageous over other aspects or designs.

Further, the term “or” is intended to signify an inclusive “or” rather than an exclusive “or”. In other words, unless otherwise specified or contextually unclear, the expression “X uses A or B” is intended to signify one of natural inclusive substitutions. That is, when X uses A; X uses B; or X uses both A and B, the expression “X uses A or B” may be applied to either of the above cases. In addition, it is to be understood that the term “and/or” used herein refers to and includes all possible combinations of one or more of listed relevant items.

In addition, it is to be understood that the terms “include” and/or “comprise” indicate the presence of corresponding features and/or elements, but do not preclude the presence or addition of one or more other features, elements, and/or groups thereof.

Further, in the present disclosure, it is to be understood that singular expressions such as “a(n)” and “the” include plural expressions as well, unless explicitly indicated otherwise. Accordingly, as an example, a “component surface” includes one or more component surfaces.

In addition, although the terms including an ordinal number such as “first” or “second” may be used to describe various elements, the elements are not limited by the terms. The above terms are used merely for the purpose of distinguishing one element from another element. For example, a first element may be termed as a second element, and similarly, a second element may also be termed as a first element without departing from the scope of the present invention. The term “and/or” includes any combination of a plurality of described relevant items, or one of the described relevant items.

Further, the terms used herein are used only to describe specific embodiments, and are not intended to limit the present invention. Unless the context explicitly indicates otherwise, an expression in a singular form includes a meaning of a plural form as well. In the present disclosure, the term such as “include” or “have” is intended to designate the presence of characteristics, numbers, steps, operations, elements, parts, or combinations thereof described herein, and shall not be construed to preclude any possibility of the presence or addition of one or more other characteristics, numbers, steps, operations, elements, parts, or combinations thereof.

In addition, unless defined otherwise, all terms used in embodiments of the present invention, including technical and scientific terms, have the same meaning as those commonly understood by a person having ordinary skill in the art to which the present invention pertains. Any terms as those defined in generally used dictionaries are to be interpreted to have the meanings equal to the contextual meanings in the relevant field of art, and are not to be interpreted to have idealistic or excessively formalistic meanings unless explicitly defined in the embodiments of the present invention.

Structure of High-Gloss Pattern Film 1 for Vehicle

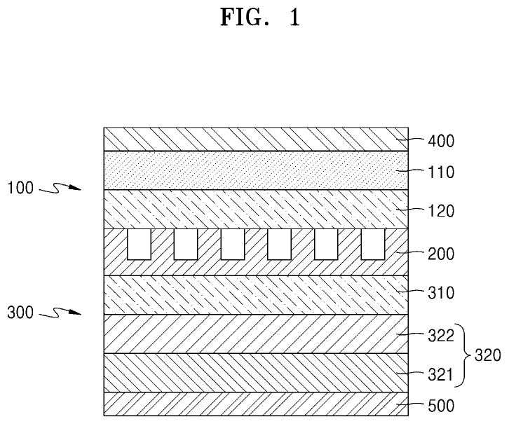

FIG. 1 schematically shows a stacked structure of a high-gloss pattern film 1 for a vehicle according to one embodiment of the present invention.

According to one embodiment of the present invention, a high-gloss pattern film 1 for a vehicle may include: a self-restoration layer 110 including polyurethane methacrylate and an isocyanate curing agent; a first base layer 120 disposed under the self-restoration layer 110, and including a thermoplastic polyurethane film; a pattern layer 200 disposed under the first base layer 120, and formed on a top surface thereof with a pattern including a concavo-convex portion; a second base layer 310 disposed under the pattern layer 200, and including a thermoplastic polyurethane film; and a third base layer 320 disposed under the second base layer 310, and including an adhesive layer 321, wherein a portion of the top surface of the pattern layer 200 is laminated to the first base layer 120 so that an empty space caused by the concavo-convex portion is formed between the pattern layer 200 and the first base layer 120.

According to one embodiment of the present invention, the third base layer 320 may further include a color layer 322 disposed on the adhesive layer 321.

As shown in FIG. 1, according to one embodiment of the present invention, the high-gloss pattern film 1 for the vehicle may include: a self-restoration layer 110; a first base layer 120 disposed under the self-restoration layer 110; a pattern layer 200 disposed under the first base layer 120; a second base layer 310 disposed under the pattern layer 200; and a third base layer 320 disposed under the second base layer 310. In addition, the third base layer 320 may include: a color layer 322 disposed under the second base layer 310; and an adhesive layer 321 disposed under the color layer 322.

In other words, the high-gloss pattern film 1 for the vehicle may include the self-restoration layer 110, the first base layer 120, the pattern layer 200, the second base layer 310, and the third base layer 320.

According to one embodiment of the present invention, the self-restoration layer 110 may include the polyurethane methacrylate and the isocyanate curing agent.

Self-restoration layers 110 of existing protective films of vehicles have low performance for scratch restoration and water repellence capabilities. Accordingly, the self-restoration layers 110 of the existing protective films of the vehicles have a low contamination resistance so as to be vulnerable to external contamination.

In order to solve the above problem, the self-restoration layer 110 including the above components may be formed on a surface of the high-gloss pattern film 1 for the vehicle according to the present invention. In this case, the self-restoration layer 110 may have excellent scratch restoration, water repellency, and contamination resistance, so that a painted surface of the vehicle may be effectively protected from scratches or contamination.

Preferably, according to one embodiment of the present invention, the self-restoration layer 110 may include 75 to 90 parts by weight of the polyurethane methacrylate, and 15 to 40 parts by weight of the isocyanate curing agent.

A composition range of the self-restoration layer 110 as described above may correspond to a range capable of implementing a self-restoration property of self-restoring scratches.

In other words, since the self-restoration layer 110 is formed based on the above composition, the high-gloss pattern film 1 for the vehicle may implement a self-restoration ability that is suitable for self-restoring scratches generated on the surface of the high-gloss pattern film 1 for the vehicle. Accordingly, when a scratch is generated on the surface of the high-gloss pattern film 1 for the vehicle, the scratch may be self-restored by the self-restoration layer 110, so that a scratch resistance may be improved.

In addition, the composition range of the self-restoration layer 110 as described above may correspond to a range capable of implementing excellent water repellency.

In other words, sine the self-restoration layer 110 is formed based on the above composition, the high-gloss pattern film 1 for the vehicle may implement excellent water repellency that does not easily allow contaminants such as rainwater, mud, and insects to penetrate into the surface of the high-gloss pattern film 1 for the vehicle. Accordingly, when contaminants are put on the surface of the high-gloss pattern film 1 for the vehicle, the contaminants may not penetrate into the surface of the high-gloss pattern film 1 for the vehicle due to the self-restoration layer 110, so that a contamination resistance may be improved.

In other words, the self-restoration layer 110 may be formed so that the high-gloss pattern film 1 for the vehicle having excellent scratch resistance, water repellency, and contamination resistance may be implemented.

Preferably, according to the high-gloss pattern film 1 for the vehicle, the self-restoration layer 110 may be formed of a material having high elasticity, so that the scratch resistance, the water repellency, and the contamination resistance of the high-gloss pattern film 1 for the vehicle may be improved, and thus the painted surface may be effectively protected.

According to one embodiment of the present invention, the first base layer 120 may be disposed under the self-restoration layer 110.

Existing pattern films for vehicles are manufactured by coating a pattern layer 200 with a self-restoration layer 110 immediately after forming a pattern including a concavo-convex portion on a top surface of the pattern layer 200. In this case, even an inner side of the concavo-convex portion may be coated with the self-restoration layer 110, so that gloss deterioration of the pattern film may occur.

In order to solve the above problem, according to the present invention, the first base layer 120 may be disposed under the self-restoration layer 110. In this case, due to the first base layer 120, the pattern layer 200 may not be coated with the self-restoration layer 110, so that the gloss deterioration of the film may be prevented.

In more detail, the first base layer 120 may be disposed between the self-restoration layer 110 and the pattern layer 200 so as to prevent the self-restoration layer 110 from filling the pattern formed on the pattern layer 200. In this case, an empty space caused by the pattern may be maintained, so that the gloss deterioration of the film may be prevented.

In other words, since the first base layer 120 is laminated to the top surface of the pattern formed on the pattern layer 200, gloss of the high-gloss pattern film 1 for the vehicle may be effectively improved.

Preferably, the first base layer 120 may be disposed between the self-restoration layer 110 and the pattern layer 200 so as to be laminated to the top surface of the pattern formed on the pattern layer 200, so that the high-gloss pattern film 1 for the vehicle having excellent gloss may be provided.

In addition, according to one embodiment of the present invention, the first base layer 120 may include the thermoplastic polyurethane film, preferably, 95 to 100 parts by weight of the thermoplastic polyurethane film.

The existing pattern films for the vehicles are formed of a PVC material, so that various colors and patterns may be implemented relatively simply. However, due to nature of the material, the material may be easily damaged even when a small impact is applied from an external environment.

In order to solve the above problem, the first base layer 120 including the above material may be formed in the high-gloss pattern film 1 for the vehicle according to the present invention.

Thermoplastic polyurethane is a material that requires a very long time to break and has relatively high elasticity, resulting in excellent durability and impact resistance. The first base layer 120 including the thermoplastic polyurethane may have excellent durability and impact resistance.

In other words, due to the first base layer 120 formed of the thermoplastic polyurethane film, the high-gloss pattern film 1 for the vehicle having excellent durability and impact resistance may be implemented.

In addition, according to one embodiment of the present invention, a thickness of the first base layer 120 may be 25 to 200 micrometers. Preferably, the thickness of the first base layer 120 may be 100 micrometers or more.

A thickness range of the first base layer 120 as described above may correspond to a range capable of implementing excellent durability and impact resistance while implementing excellent gloss.

Preferably, since the first base layer 120 has the above thickness, an impact from an outside may be effectively absorbed, and the empty space formed by the concavo-convex portion in the pattern layer 200 may be prevented from being pressed so that the high-gloss pattern film 1 for the vehicle having excellent gloss may be implemented.

In other words, since the first base layer 120 is formed of the above components with the above thickness, the high-gloss pattern film 1 for the vehicle having the excellent durability and impact resistance and the excellent gloss may be implemented.

According to one embodiment of the present invention, the pattern layer 200 may be disposed under the first base layer 120, and may be formed on the top surface thereof with the pattern including the concavo-convex portion.

As described above, the first base layer 120 may be disposed between the self-restoration layer 110 and the pattern layer 200 so as to prevent the self-restoration layer 110 from filling the pattern formed on the pattern layer 200.

In other words, according to one embodiment of the present invention, the pattern including the concavo-convex portion may be maintained on the top surface of the pattern layer 200, so that the empty space may be formed.

In this case, when a light is incident on the pattern layer 200, diffuse reflection may be suppressed by the concavo-convex portion, and a three-dimensional effect of a pattern of the high-gloss pattern film 1 for the vehicle may be improved.

In addition, according to one embodiment of the present invention, the pattern may be formed by rolling the top surface of the pattern layer 200 that is applied with a predetermined thickness by using a roll engraved with a predetermined pattern.

In other words, the pattern may formed by a surface coating scheme rather than a surface printing scheme so as to have a relatively three-dimensional characteristic. In this case, although the pattern may cause refraction of the light so as to reduce the gloss of the film, the excellent gloss may be implemented due to a laminated structure with the first base layer 120.

In addition, according to one embodiment of the present invention, the pattern layer 200 may include 75 to 90 parts by weight of the polyurethane methacrylate, and 15 to 40 parts by weight of the isocyanate curing agent.

A composition range of the pattern layer 200 as described above may correspond to a range capable of implementing a layer in which a three-dimensional pattern may be formed through the rolling by the roll. In other words, since the pattern layer 200 is formed of the above components, the pattern including the concavo-convex portion may be formed on the top surface of the pattern layer 200 by the surface coating scheme.

However, the components and the composition of the pattern layer 200 are not limited to the above configuration, and may be variably selected according to a working environment such as complexity and a size of the pattern.

According to one embodiment of the present invention, the second base layer 310 may be disposed under the pattern layer 200, and may include the thermoplastic polyurethane film, preferably, 95 to 100 parts by weight of the thermoplastic polyurethane film.

As described above, the thermoplastic polyurethane is a material having high elasticity, resulting in excellent durability and impact resistance. In other words, due to the second base layer 310 formed of the thermoplastic polyurethane film, durability and an impact resistance of the high-gloss pattern film 1 for the vehicle may be improved.

In addition, according to one embodiment of the present invention, a thickness of the second base layer 310 may be 12 to 50 micrometers.

In general, as a total thickness of a film attached to a painted surface of a vehicle increases, construction of the film may become more difficult.

In consideration of the above problem, according to the present invention, the second base layer 310 may have the above thickness range. In other words, since the second base layer 310 is formed to be relatively thinner than the first base layer 120, constructability of the high-gloss pattern film 1 for the vehicle may be improved.

According to one embodiment of the present invention, the third base layer 320 may be disposed under the second base layer 310, and may include the adhesive layer 321.

In addition, as described above, according to one embodiment of the present invention, the third base layer 320 may further include the color layer 322 disposed on the adhesive layer 321.

As shown in FIG. 1, according to one embodiment of the present invention, the third base layer 320 may include: the color layer 322 disposed under the second base layer 310; and the adhesive layer 321 disposed under the color layer 322.

According to one embodiment of the present invention, the color layer 322 may include: 50 to 60 parts by weight of a urethane acrylate binder; 5 to 10 parts by weight of a color pigment; 1 to 5 parts by weight of a curing agent; and 30 to 60 parts by weight of a solvent.

The existing pattern films for the vehicles implement a color by performing surface printing or adding a pigment to thermoplastic polyurethane or an adhesive layer 321.

However, since the film is formed of the PVC material, the film may not be suitable for protecting the painted surface of the vehicle, a yellowing phenomenon may be emphasized when the pigment is directly added to the thermoplastic polyurethane, and there may be a risk of elution of a color caused by a construction solution, which reduces physical properties, when the pigment is added to the adhesive layer 321.

In order to solve the above problem, a separate color layer 322 may be disposed under the second base layer 310 in the high-gloss pattern film 1 for the vehicle according to the present invention. In this case, since the color layer 322 includes a component having the above composition range, various colors may be stably implemented.

In other words, according to the high-gloss pattern film 1 for the vehicle, the color layer 322 including the color pigment may be separately arranged, so that various colors may be stably implemented.

In addition, the composition range of the color layer 322 as described above may correspond to a range capable of implementing various colors while implementing adhesion. In this case, the color layer 322 may correspond to a primer layer.

In more detail, according to one embodiment of the present invention, when the adhesive layer 321 includes an acryl-based component, the adhesive layer 321 may not well adhere to the second base layer 310 including the thermoplastic polyurethane. In this case, the color layer 322 including a urethane acrylate binder may be disposed between the second base layer 310 and the adhesive layer 321, so that adhesion between the second base layer 310 and the adhesive layer 321 may be enhanced.

In other words, since the color layer 322 is formed of a material based on a component that is similar to a component on which materials of the second base layer 310 and the adhesive layer 321 are based, the color layer 322 may serve as a primer, and thus the adhesive layer 321 may be prevented from being transferred.

However, the components and the composition range of the color layer 322 are not limited to the above configuration, and may be variably selected according to a required color or texture. For example, according to another embodiment of the present invention, the color layer 322 may include an acryl-based binder including an acryl copolymer.

Meanwhile, according to one embodiment of the present invention, the adhesive layer 321 may include: 70 to 80 parts by weight of an acryl copolymer; 0.5 to 5 parts by weight of a curing agent; and 30 to 60 parts by weight of a solvent.

When the existing pattern film for the vehicle is constructed, an acryl-based adhesive agent having high adhesive strength is mainly used to prevent lifting of the film.

However, since the acryl-based adhesive agent has low adhesion with respect to the thermoplastic polyurethane, the adhesive agent may be transferred to the painted surface of the vehicle when the film is removed.

In order to solve the above problem, according to the present invention, the adhesive layer 321 including a component having the above composition range may be formed. The composition range of the adhesive layer 321 as described above may correspond to a range that exhibits strong adhesion. Accordingly, lifting of the high-gloss pattern film 1 for the vehicle may be prevented.

In addition, according to one embodiment of the present invention, in order to improve the adhesion between the second base layer 310 and the adhesive layer 321, the color layer 322 may be disposed between the second base layer 310 and the adhesive layer 321. Accordingly, the transfer may be prevented when the high-gloss pattern film 1 for the vehicle is removed.

However, the components and the composition of the adhesive layer 321 are not limited to the above configuration, and may be variably selected according to a construction target and a construction environment.

Meanwhile, as shown in FIG. 1, the high-gloss pattern film 1 for the vehicle may include a protective film layer 400 disposed on the self-restoration layer 110. Accordingly, the surface of the high-gloss pattern film 1 for the vehicle may be protected by the protective film layer 400.

Meanwhile, as shown in FIG. 1, the high-gloss pattern film 1 for the vehicle may include a release film layer 500 disposed under the adhesive layer 321.

Since the release film layer 500 has to be easily removed by a constructor upon construction of the high-gloss pattern film 1 for the vehicle, the release film layer 500 may preferably have weak peeling capability. In this case, the release film layer 500 may include any general release film in which peeling capability is difficult to become strong even when a time elapses in a state where the release film is attached to the adhesive layer 321.

As shown in FIG. 1, the high-gloss pattern film 1 for the vehicle may have a layered structure in which the self-restoration layer 110, the first base layer 120, the pattern layer 200, the second base layer 310, and the third base layer 320 including the color layer 322 and the adhesive layer 321 are stacked.

According to one embodiment of the present invention, a thickness of the self-restoration layer 110 may be 5 to 30 micrometers, a thickness of the first base layer 120 may be 25 to 200 micrometers, a thickness of the pattern layer 200 may be to 50 micrometers, a thickness of the second base layer 310 may be 12 to 50 micrometers, and a thickness of the adhesive layer 321 may be 5 to 50 micrometers. In addition, a thickness of the color layer 322 may be 5 to 50 micrometers.

Since each layer constituting the high-gloss pattern film 1 for the vehicle according to the present invention is formed in the above thickness range, the high-gloss pattern film 1 for the vehicle, which has the excellent gloss, implements various patterns and colors, and has the excellent durability, may be provided.

Meanwhile, as shown in FIG. 1, according to one embodiment of the present invention, the high-gloss pattern film 1 for the vehicle may include: an upper film layer 100 including the self-restoration layer 110 and the first base layer 120; and a lower film layer 300 including the second base layer 310 and the third base layer 320.

In this case, the pattern layer 200 may be formed between the upper film layer 100 and the lower film layer 300, and the top surface of the pattern formed on the pattern layer 200 may be attached to the upper film layer 100 so that the upper film layer 100, the pattern layer 200, and the lower film layer 300 may form an integrated structure. In other words, due to the above structure, the high-gloss pattern film 1 for the vehicle having the excellent gloss may be provided.

Meanwhile, according to one embodiment of the present invention, there may be provided a method of manufacturing a high-gloss pattern film 1 for a vehicle, in which the high-gloss pattern film 1 for the vehicle includes: a self-restoration layer 110 including polyurethane methacrylate and an isocyanate curing agent; a first base layer 120 disposed under the self-restoration layer 110, and including a thermoplastic polyurethane film; a pattern layer 200 disposed under the first base layer 120, and formed on a top surface thereof with a pattern including a concavo-convex portion; a second base layer 310 disposed under the pattern layer 200, and including a thermoplastic polyurethane film; and a third base layer 320 disposed under the second base layer 310, and including an adhesive layer 321, wherein a portion of the top surface of the pattern layer 200 is laminated to the first base layer 120 so that an empty space caused by the concavo-convex portion is formed between the pattern layer 200 and the first base layer 120.

In other words, the high-gloss pattern film 1 for the vehicle according to one embodiment of the present invention may be manufactured by the manufacturing method. Accordingly, the high-gloss pattern film 1 for the vehicle, which has the excellent gloss, implements various patterns and colors, and has the excellent durability, may be provided.

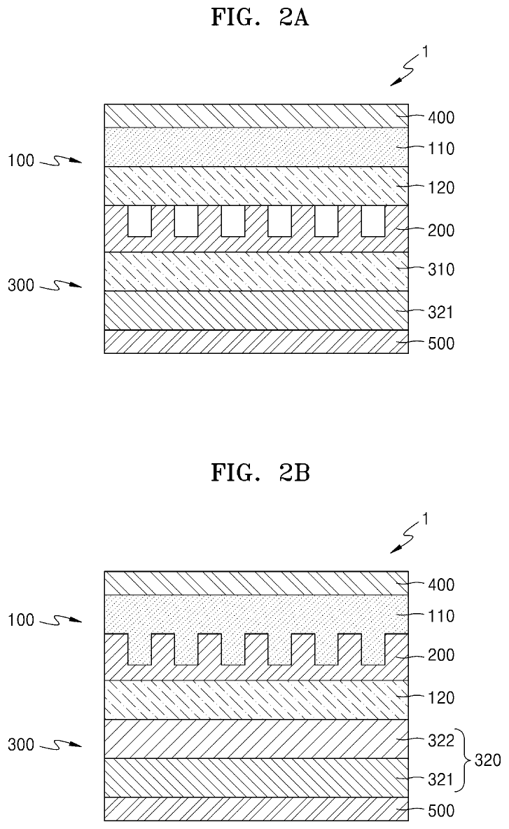

FIGS. 2A and 2B schematically show stacked structures of high-gloss pattern films 1 for vehicles according to one embodiment of the present invention.

According to one embodiment of the present invention, as shown in FIG. 2A, a high-gloss pattern film 1 for a vehicle may include: an upper film layer 100 including a self-restoration layer 110 and a first base layer 120; a pattern layer 200 disposed under the upper film layer 100; and a lower film layer 300 disposed under the pattern layer 200, and including a second base layer 310 and an adhesive layer 321.

In other words, according to one embodiment of the present invention, the high-gloss pattern film 1 for the vehicle may not include a color layer 322. Preferably, according to one embodiment of the present invention, the high-gloss pattern film 1 for the vehicle capable of imparting only a pattern without changing a color of the vehicle may be provided.

Accordingly, the high-gloss pattern film 1 for the vehicle may be suitable for construction even when a painted surface of a construction target does not have a white color or a user does not desire to change a painted color of the vehicle.

Meanwhile, according to one embodiment of the present invention, as shown in FIG. 2B, a high-gloss pattern film 1 for a vehicle may include: an upper film layer 100 including a self-restoration layer 110 and a first base layer 120; a pattern layer 200 disposed in a middle of the upper film layers 100; and a lower film layer 300 disposed under the pattern layer 200, and including a color layer 322 and an adhesive layer 321.

In other words, according to one embodiment of the present invention, the high-gloss pattern film 1 for the vehicle may not include a second base layer 310. Preferably, according to one embodiment of the present invention, the high-gloss pattern film 1 for the vehicle in which the self-restoration layer 110 is formed on the pattern layer 200 may be provided.

As described above, the high-gloss pattern film 1 for the vehicle may have one or more stacked structures according to embodiments of the present invention.

Accordingly, according to the present invention, the high-gloss pattern film 1 for the vehicle capable of imparting only the pattern without changing the color of the vehicle, or imparting the pattern while changing the color of the vehicle may be provided.

Characteristic Comparison Experiment for High-Gloss Pattern Film 1 for Vehicle

Hereinafter, Examples and Comparative Examples according to the present invention will be described. In addition, results of a characteristic test for Examples and Comparative Examples will be described in detail.

Examples and Comparative Examples in the present experiment are as follows.

### Example 1

A top surface of a second base layer 310 including a thermoplastic polyurethane film having a thickness of 25 micrometers was coated with a pattern layer 200 including 80 parts by weight of polyurethane methacrylate and 32 parts by weight of an isocyanate curing agent to form a pattern, the pattern layer 200 was laminated with a first base layer 120 including a thermoplastic polyurethane film having a thickness of 150 micrometers, a self-restoration layer 110 including 80 parts by weight of polyurethane methacrylate and 32 parts by weight of an isocyanate curing agent was formed on a top surface of the first base layer 120, a color layer 322 including 60 parts by weight of a urethane acrylate binder, 6 parts by weight of a color pigment, 2 parts by weight of a curing agent, and 50 parts by weight of a solvent was formed on a bottom surface of the second base layer 310, and an adhesive layer 321 including 70 parts by weight of an acryl copolymer, 1 part by weight of a curing agent, and 55 parts by weight of a solvent was formed on a bottom surface of the color layer 322, so that a high-gloss pattern film 1 for a vehicle was manufactured. In other words, Example 1 may include the above-described stacked structure as in FIG. 1.

### Example 2

A top surface of a first base layer 120 including a thermoplastic polyurethane film having a thickness of 150 micrometers was coated with a pattern layer 200 including 80 parts by weight of polyurethane methacrylate and 32 parts by weight of an isocyanate curing agent to form a pattern, a self-restoration layer 110 including 80 parts by weight of polyurethane methacrylate and 32 parts by weight of an isocyanate curing agent was formed after curing of the pattern layer 200 is completed, a color layer 322 including 60 parts by weight of a urethane acrylate binder, 6 parts by weight of a color pigment, 2 parts by weight of a curing agent, and 50 parts by weight of a solvent was formed on a bottom surface of the first base layer 120, and an adhesive layer 321 including 70 parts by weight of an acryl copolymer, 1 part by weight of a curing agent, and 55 parts by weight of a solvent was formed on a bottom surface of the color layer 322, so that a high-gloss pattern film 1 for a vehicle was manufactured. In other words, Example 2 may include the above-described stacked structure as in FIG. 2(b).

### Comparative Example 1

A PVC color wrapping film (product name: Carbon Real) on sale by CYS was used. In other words, Comparative Example 1 corresponds to a pattern film for a vehicle, which is formed of a PVC material.

### Comparative Example 2

A color TPU PPF (product name: G-suit) on sale by Ad-Winner was used. In other words, Comparative Example 2 corresponds to a PPF in which a color is directly implemented in thermoplastic polyurethane.

### Comparative Example 3

A color PSA PPF was used. In other words, Comparative Example 3 corresponds to a PPF in which a color is implemented by adding a pigment to an adhesive layer 321.

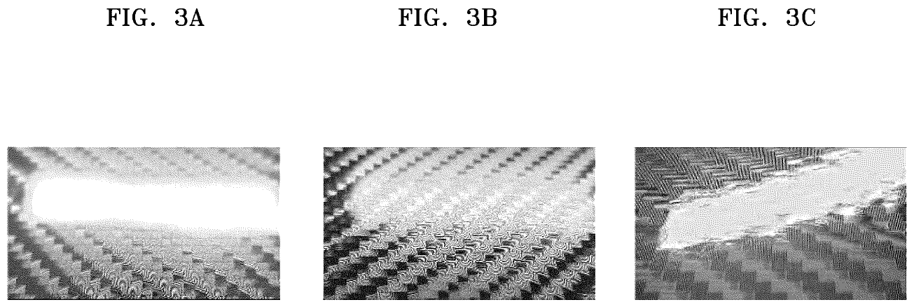

FIGS. 3A, 3B, and 3C schematically show external appearances of high-gloss pattern films 1 for vehicles according to one embodiment of the present invention and a comparative example.

FIG. 3A shows an external appearance in which a pattern form of Example 1 may be observed, FIG. 3B shows an external appearance in which a pattern form of Example 2 may be observed, and FIG. 3C shows an external appearance in which a pattern form of Comparative Example 1 may be observed.

As shown in FIGS. 3A to 3C, it may be found that all of Example 1, Example 2, and Comparative Example 1 are products to which a carbon pattern is applied.

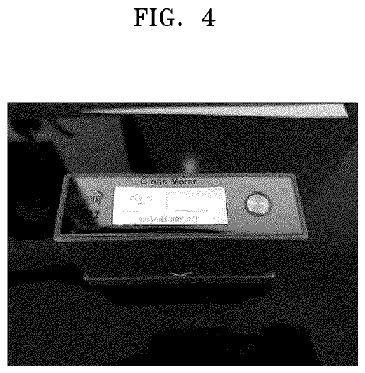

FIG. 4 schematically shows a tester used for a glossiness test.

In the present experiment, a glossiness test was performed by using LS-192 equipment from LINSHANG. In this test, glossiness may be measured by irradiating a product with a light at a predetermined angle, and a higher measurement value means that the product is glossier when viewed with a naked eye.

Table 1 shows results of the glossiness test for Example 1, Example 2, and Comparative Example 1.

TABLE 1

| Film | Glossiness |
|---|---|
| Example 1 | 123.1 |
| Example 2 | 39.5 |
| Comparative Example 1 | 97.2 |

As shown in Table 1, it was found that glossiness of Example 1 is 123.1, glossiness of Example 2 is 39.5, and glossiness of Comparative Example 1 is 97.2.

Example 1 corresponds to a film in which a separate base layer is present between the self-restoration layer 110 and the pattern layer 200. In this case, an empty space may be maintained within the pattern of the pattern layer 200, so that diffuse reflection of the light irradiated onto the film may be suppressed, and thus excellent gloss may be implemented.

Meanwhile, Example 2 corresponds to a film in which a separate base layer is not present between the self-restoration layer 110 and the pattern layer 200. In this case, the self-restoration layer 110 may be filled within the pattern of the pattern layer 200, so that the light irradiated onto the film may be refracted by the pattern, and thus gloss may be rapidly reduced.

In addition, Comparative Example 1 corresponds to a film in which a pattern and a color are formed through surface printing. It may be found that Comparative Example 1 may implement relatively excellent glossiness as compared with Example 2, while the glossiness of Comparative Example 1 is relatively decreased as compared with Example 1 due to diffuse reflection caused by the pattern.

In other words, it may be found that Example 1 has relatively excellent glossiness among the high-gloss pattern films 1 for the vehicles according to one embodiment of the present invention.

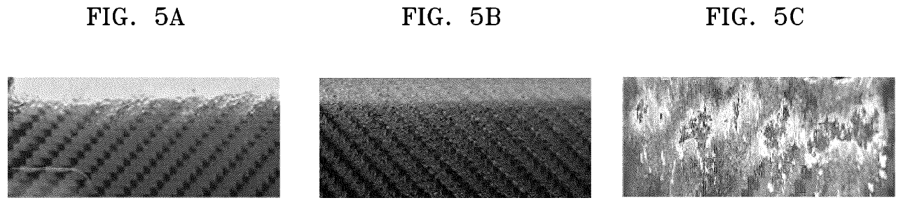

FIGS. 5A, 5B, and 5C schematically show results of an impact resistance test for the high-gloss pattern films 1 for the vehicles according to one embodiment of the present invention and the comparative example.

In this experiment, an impact resistance test was performed by using gravelometer test equipment. This test may determine a degree by which a product may be protected when an impact is applied to the surface of the film by using a weight attached to the equipment.

FIGS. 5A, 5B, and 5C schematically show results of the impact resistance test for Example 1, Example 2, and Comparative Example 1, respectively.

As shown in FIG. 5A and FIG. 5B, it was found that the films according to Example 1 and Example 2 are not damaged due to inherent elasticity and restoration capability of the first base layer 120 and the second base layer 310.

Meanwhile, as shown in FIG. 5C, it was found that the film according to Comparative Example 1 is severely damaged because the film is formed of the PVC material that does not have elasticity and restoration capability.

As described above, it may be determined that Example 1 and Example 2 of the present invention have very excellent impact absorption performance. In this case, the first base layer 120 and the second base layer 310 according to Example 1 and Example 2 include the thermoplastic polyurethane, and a base layer according to Comparative Example 1 includes PVC.

In other words, since the first base layer 120 and the second base layer 310 are formed of the thermoplastic polyurethane, an impact resistance of the high-gloss pattern film 1 for the vehicle according to one embodiment of the present invention may be improved.

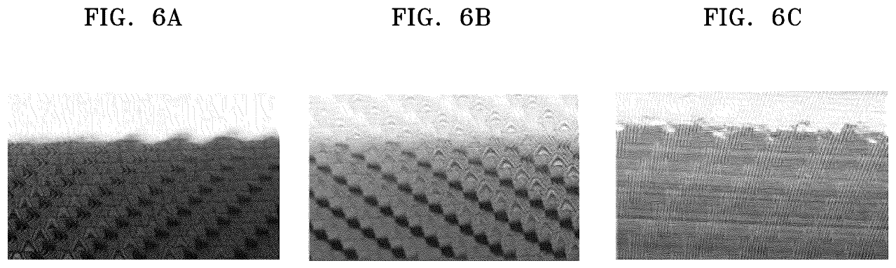

FIGS. 6A, 6B, and 6C schematically show results of a scratch restoration capability test for the high-gloss pattern films 1 for the vehicles according to one embodiment of the present invention and the comparative example.

In this experiment, scratches were generated on a surface of a film with steel wool (#0000) under conditions of 80 rpm and 200 reciprocations by using rubbing test equipment. After the scratches are generated, heat was applied to the surface of the film by using a dryer to determine whether the scratches are restored.

FIGS. 6A, 6B, and 6C schematically show results of the scratch restoration capability test for Example 1, Example 2, and Comparative Example 1, respectively.

As shown in FIG. 6A and FIG. 6B, it was found that in Example 1 and Example 2, all the scratches are restored after the heat is applied by using the dryer.

Meanwhile, as shown in FIG. 6C, it was found that in Comparative Example 1, all the scratches generated on the surface of the film remain intact because there is no self-restoration layer 110.

As described above, according to Example 1 and Example 2 of the present invention, most of the scratches generated on the surface may be effectively restored by the self-restoration layer 110 having scratch restoration capability.

In other words, the high-gloss pattern film 1 for the vehicle according to one embodiment of the present invention may self-restore scratches by the self-restoration layer 110 when the scratches are generated on the surface of the high-gloss pattern film 1 for the vehicle, so that the scratch resistance may be improved.

In addition, according to the results of FIGS. 5A, 5B, and 5C and FIGS. 6A, 6B, and 6C, the high-gloss pattern film 1 for the vehicle according to one embodiment of the present invention may be determined as being capable of effectively protecting the painted surface of the vehicle from an external impact. Meanwhile, Comparative Example 1 may be determined as being incapable of protecting the painted surface of the vehicle from the external impact.

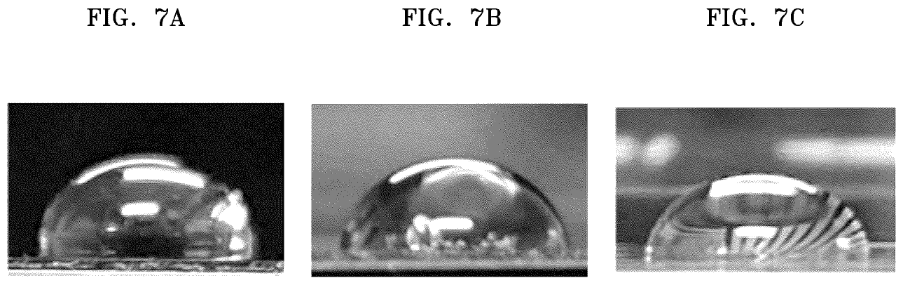

FIGS. 7A, 7B, and 7C schematically shows results of a water repellence capability test for the high-gloss pattern films 1 for the vehicles according to one embodiment of the present invention and the comparative example.

In this experiment, a water droplet of the same mass was dropped on the surface of the film by using a micropipette, and a shape of the water droplet formed on the surface was observed.

FIGS. 7A, 7B, and 7C schematically show results of the water repellence capability test for Example 1, Example 2, and Comparative Example 1, respectively.

As shown in FIG. 7A, it was found that a water droplet dropped on a surface of Example 1 has a round shape. In other words, it may be found that Example 1 exhibits excellent water repellence capability.

In addition, as shown in FIG. 7B, it was found that a water droplet dropped on a surface of Example 2 has a relatively spread shape as compared with Example 1. In a case of Example 2, it may be determined that although water repellence capability that is similar to the water repellence capability of Example 1 is implemented by the self-restoration layer 110, since the pattern layer 200 is coated with the self-restoration layer 110, the pattern formed on the pattern layer 200 is slightly raised upward, so that the water repellence capability of Example 2 is relatively reduced.

Meanwhile, as shown in FIG. 7C, it was found that a water droplet dropped on a surface of Comparative Example 1 has an elongated shape. In a case of Comparative Example 1, it may be found that Comparative Example 1 exhibits relatively low water repellence capability because there is no self-restoration layer 110 on the surface.

As described above, Example 1 and Example 2 according to the present invention may have excellent water repellence capability due to the self-restoration layer 110 formed on the surface. In other words, the high-gloss pattern film 1 for the vehicle according to one embodiment of the present invention may be determined as being capable of effectively protecting the painted surface because the water repellency is improved by the self-restoration layer 110.

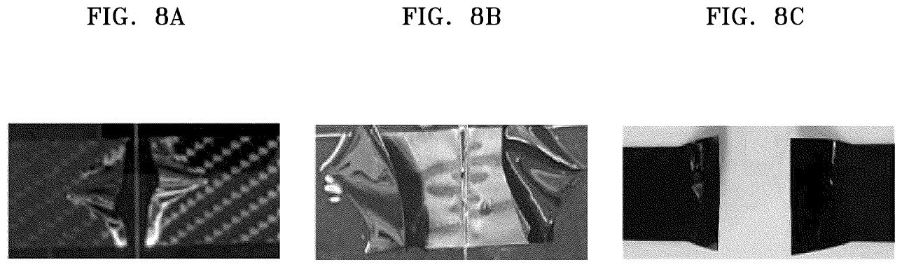

FIGS. 8A, 8B, and 8C schematically show results of an adhesion retention strength test for the high-gloss pattern films 1 for the vehicles according to one embodiment of the present invention and the comparative example.

In this experiment, each film was sampled in a size of 2.5 cm*19 cm, and attached to the same position. Thereafter, a center of each film was cut with a knife to determine retention strength of an adhesive agent for 24 hours.

FIGS. 8A, 8B, and 8C schematically show results of the adhesion retention strength test for Example 1, Comparative Example 2, and Comparative Example 3, respectively.

As shown in FIG. 8A, Example 1 exhibits excellent adhesion retention strength. This is because a color is not directly added to the adhesive layer 321 according to Example 1 so that physical properties of the adhesive layer 321 are stable, and the color layer 322 serves as a primer.

In addition, as shown in FIG. 8B, it may be found that in Comparative Example 2, peeling occurs between a base layer and an adhesive agent. This is because adhesion between the base layer and an adhesive layer 321 is reduced as the color is directly added to the base layer including thermoplastic polyurethane.

Meanwhile, as shown in FIG. 8C, it may be found that in Comparative Example 3, there is a large gap between cut surfaces. This is because physical properties of the adhesive layer 321 deteriorate as the color is implemented by adding the pigment to the adhesive layer 321.

In other words, when Comparative Example 2 and Comparative Example 3 are constructed on a vehicle having many curved portions on an exterior of the vehicle, such as a sports car, lifting of the film may occur, or transfer of the adhesive agent may occur.

As described above, according to Example 1 of the present invention, the color pigment may be added to the color layer 322 to implement a color, so that adhesion retention strength of the high-gloss pattern film 1 for the vehicle may be improved.

According to one embodiment of the present invention, the self-restoration layer may be formed of a material having high elasticity, so that a scratch resistance and water repellency of the high-gloss pattern film for the vehicle can be improved, and thus a painted surface can be effectively protected.

According to one embodiment of the present invention, the first base layer may be disposed between the self-restoration layer and the pattern layer so as to be laminated to the top surface of the pattern formed on the pattern layer, so that the high-gloss pattern film for the vehicle having excellent gloss can be provided.

According to one embodiment of the present invention, the first base layer formed of the thermoplastic polyurethane film and having a relatively thick thickness may be disposed on a surface side, so that durability and an impact resistance of the high-gloss pattern film for the vehicle can be improved.

According to one embodiment of the present invention, a color layer including a color pigment may be separately arranged, so that various colors can be stably implemented.

According to one embodiment of the present invention, the color layer may be formed of a material based on a component that is similar to a component on which materials of the second base layer and the adhesive layer are based, so that the color layer can serve as a primer, and thus the adhesive layer can be prevented from being transferred.

The descriptions of the embodiments set forth herein are provided to enable any person having ordinary skill in the art to use or implement the present invention. It will be apparent to the person having ordinary skill in the art that various modifications can be made to the embodiments, and general principles defined herein may be applied to other embodiments without departing from the scope of the present invention. Accordingly, the present invention is not limited to the embodiments set forth herein, but is to be construed in the broadest scope consistent with the principles and novel features set forth herein.

What is claimed is:

1. A high-gloss pattern film for a vehicle, the high-gloss pattern film comprising:
a self-restoration layer including polyurethane methacrylate and an isocyanate curing agent;
a first base layer disposed under the self-restoration layer, and including a thermoplastic polyurethane film;
a pattern layer disposed under the first base layer;
a second base layer disposed under the pattern layer, and including a thermoplastic polyurethane film; and
a third base layer disposed under the second base layer, and including an adhesive layer,
wherein a portion of a top surface of the pattern layer is laminated to the first base layer and said top surface has a concavo-convex shape which forms empty spaces between the pattern layer and the first base layer.

2. The high-gloss pattern film of claim 1, wherein the self-restoration layer includes 75 to 90 parts by weight of the polyurethane methacrylate, and 15 to 40 parts by weight of the isocyanate curing agent.

3. The high-gloss pattern film of claim 1, wherein each of the first base layer and the second base layer includes 95 to 100 parts by weight of the thermoplastic polyurethane film.

4. The high-gloss pattern film of claim 1, wherein the high-gloss pattern film for the vehicle includes:
an upper film layer including the self-restoration layer and the first base layer; and
a lower film layer including the second base layer and the third base layer, the pattern layer is formed between the upper film layer and the lower film layer, and
a top surface of the pattern formed on the pattern layer is attached to the upper film layer so that the upper film layer, the pattern layer, and the lower film layer form an integrated structure.

5. The high-gloss pattern film of claim 1, wherein the third base layer further includes a color layer disposed on the adhesive layer, and
a thickness of the color layer is 5 to 50 micrometers.

6. The high-gloss pattern film of claim 1, wherein a thickness of the self-restoration layer is 5 to 30 micrometers,
a thickness of the first base layer is 25 to 200 micrometers,
a thickness of the pattern layer is 5 to 50 micrometers,
a thickness of the second base layer is 12 to 50 micrometers, and
a thickness of the adhesive layer is 5 to 50 micrometers.

7. A method of manufacturing a high-gloss pattern film for a vehicle, in which the high-gloss pattern film for the vehicle includes: a self-restoration layer including polyurethane methacrylate and an isocyanate curing agent; a first base layer disposed under the self-restoration layer, and including a thermoplastic polyurethane film; a pattern layer disposed under the first base layer; a second base layer disposed under the pattern layer, and including a thermoplastic polyurethane film; and a third base layer disposed under the second base layer, and including an adhesive layer,
wherein a portion of a top surface of the pattern layer is laminated to the first base layer and said top surface has a concavo-convex shape which forms empty spaces between the pattern layer and the first base layer.
